(19) United States
(12) Patent Application Publication
(10) Pub. No.: US 2013/0247732 A1
(43) Pub. Date: Sep. 26, 2013

(54) ROTARY CUTTER DEVICE

(71) Applicants: Teruo IMAMAKI, Nissin-shi (JP); Akira SAGO, Seto-shi (JP)

(72) Inventors: Teruo IMAMAKI, Nissin-shi (JP); Akira SAGO, Seto-shi (JP)

(73) Assignee: BROTHER KOGYO KABUSHIKI KAISHA, Nagoya-shi (JP)

(21) Appl. No.: 13/776,864

(22) Filed: Feb. 26, 2013

(30) Foreign Application Priority Data
Mar. 21, 2012 (JP) 2012-064070

(51) Int. Cl. B26D 7/18

(52) U.S. Cl. CPC B26D 7/1818
USPC 83/168

(57) ABSTRACT

A rotary cutter device includes a rotary blade, a fixed blade, a control portion, and a blade member. The rotary blade is configured to be rotatable around a central axis and has a first cutting edge. The fixed blade is provided on an outer side of a trajectory and has a second cutting edge. The control portion is configured to cause the rotary blade to rotate toward the fixed blade around the central axis. The blade member is provided opposite the trajectory in a different position from the fixed blade. The blade member is a plate-shaped member that has a width that extends parallel to the central axis and has a slide portion that is configured to slide in relation to the first cutting edge of the rotating rotary blade.

### CROSS-REFERENCE TO RELATED APPLICATION

This application claims priority to Japanese Patent Application No. 2012-64070, filed Mar. 21, 2012, the disclosure of which is incorporated herein by reference in its entirety.

### BACKGROUND

The present disclosure relates to a rotary cutter device that is configured to cut a sheet-shaped object that is conveyed to the rotary cutter device.

A rotary cutter device is known that is configured to cut a sheet-shaped object that is conveyed to the rotary cutter device. The rotary cutter device is provided with a helical rotary blade on the outer circumference of a circular cylindrical body portion. The object is cut in a straight line by the rotary blade while the object is being conveyed.

### SUMMARY

In a case where the rotary cutter device cuts an adhesive tape a plurality of times in succession, adhesive from the adhesive tape accumulates on the cutting edge of the rotary blade. When the adhesive tape is cut, there is a possibility that the adhesive that has accumulated on the cutting edge will stick to the edge of the adhesive tape. This raises the possibility that the adhesive tape that is being conveyed will be dragged by the rotary blade and wound around the body portion, causing the rotary cutter device to become jammed by the adhesive tape.

In order to prevent this sort of jamming, it is preferable for the adhesive that has accumulated on the cutting edge of the rotary blade to be removed appropriately. Ordinarily, the adhesive that has accumulated on the cutting edge is periodically removed manually by an operator. Removing the adhesive by this sort of manual work is dangerous, because the operator touches the cutting edge directly. Every time the operator performs the work of removing the adhesive, it is necessary to stop the operation of the rotary cutter device, so there is a possibility that the work of cutting the adhesive tape will be interrupted.

Various exemplary embodiments of the general principles herein provide a rotary cutter device that is able to safely and precisely remove the adhesive that has accumulated on the cutting edge of the rotary blade, without interrupting the work of cutting the object.

The exemplary embodiments described herein provide a rotary cutter device that includes a rotary blade, a fixed blade, a control portion, and a blade member. The rotary blade is configured to be rotatable around a central axis. The rotary blade has a first cutting edge on an end of the rotary blade that is farthest from the central axis. The first cutting edge is a cutting edge that has a width that extends parallel to the central axis. The fixed blade is provided on an outer side of a trajectory that is described by the first cutting edge. The fixed blade has a second cutting edge that is a cutting edge that is opposite the trajectory. The control portion is configured to cause the rotary blade to rotate toward the fixed blade in a first direction around the central axis. The blade member is provided opposite the trajectory in a different position from the fixed blade. The blade member is a plate-shaped member that has a width that extends parallel to the central axis and has a slide portion that is configured to slide in relation to the first cutting edge of the rotating rotary blade.

### BRIEF DESCRIPTION OF THE DRAWINGS

Exemplary embodiments of the present disclosure will be described below in detail with reference to the accompanying drawings in which:

FIG. 1 is an oblique view of a label-making device;

FIG. 2 is a front view of the label-making device;

FIG. 3 is a section view of a main unit of the label-making device, as seen from the right side;

FIG. 4 is an oblique view of a rotary cutter device according to a first embodiment;

FIG. 5 is an oblique view of the rotary cutter device according to the first embodiment, as seen from another direction;

FIG. 6 is an oblique view of the rotary cutter device according to the first embodiment, as seen from another direction;

FIG. 7 is a rear view of the rotary cutter device according to the first embodiment;

FIG. 8 is an enlarged view of a first cutting edge on which adhesive has accumulated;

FIG. 9 is an explanatory figure that shows a flow of an operation of cutting a tape according to the first embodiment;

FIG. 10 is an oblique view of a rotary cutter device according to a second embodiment;

FIG. 11 is an explanatory figure that shows a flow of an operation of cutting a tape according to the second embodiment;

FIG. 12 is a flowchart of first cleaning processing;

FIG. 13 is a flowchart of second cleaning processing;

FIG. 14 is a flowchart of third cleaning processing; and

FIG. 15 is a flowchart of fourth cleaning processing.

### DETAILED DESCRIPTION

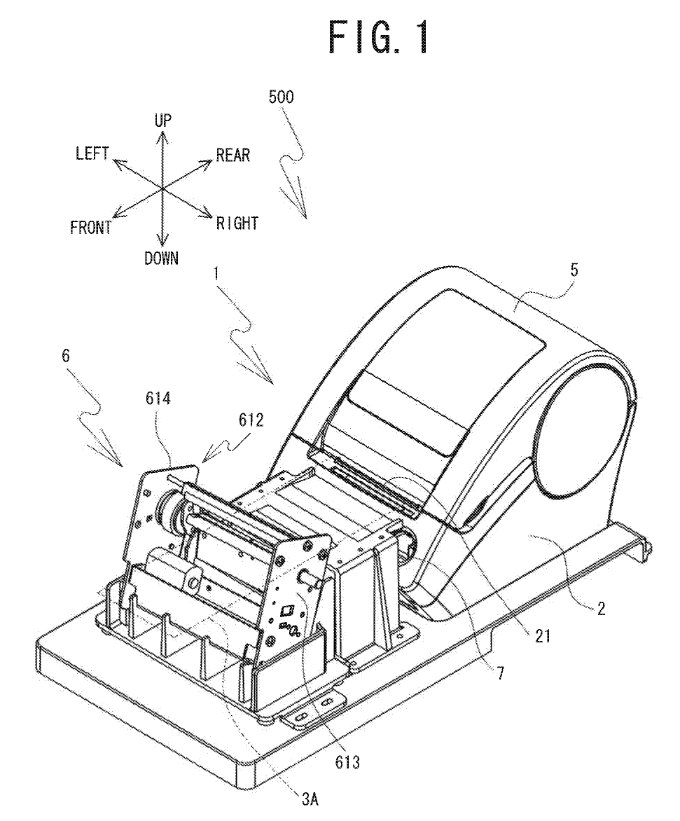

A first embodiment of the present disclosure will be explained with reference to the drawings. The present embodiment is an example of a case in which the rotary cutter device of the present disclosure is used in a label-making device. In the explanation that follows, the upper side, the lower side, the lower left side, the upper right side, the upper left side, and the lower right side in FIG. 1 are respectively defined as the upper side, the lower side, the front side, the rear side, the left side, and the right side of a label-making device 500.

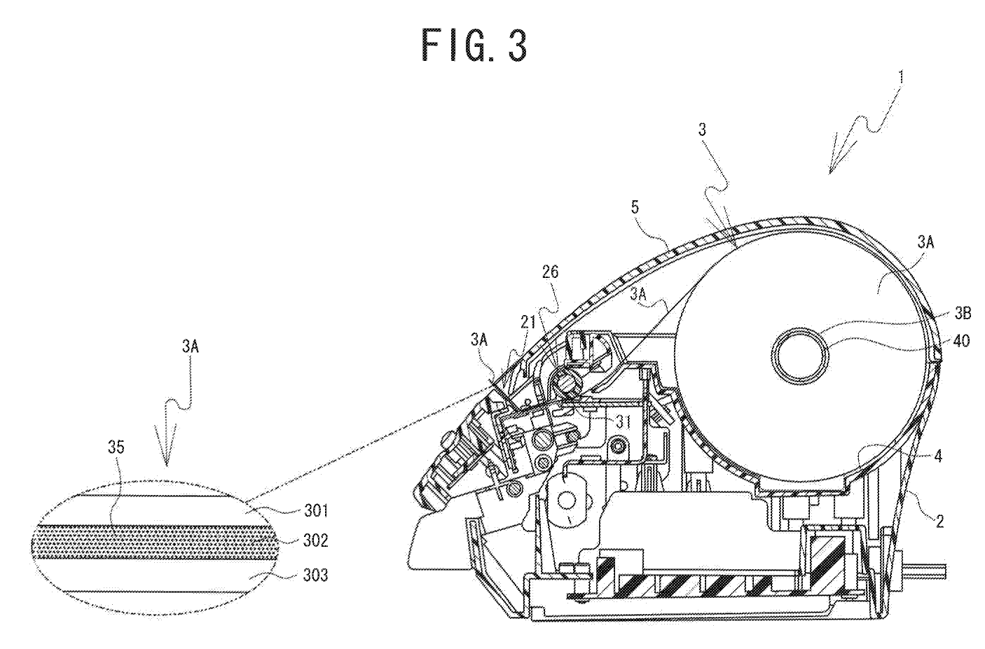

As shown in FIG. 1, the label-making device 500 is provided with a main unit 1 and a rotary cutter device 6. The main unit 1 is configured to print characters (text characters, numerals, symbols, graphics, and the like) on a long tape 3A (refer to FIG. 3). The rotary cutter device 6 is configured to cut the tape 3A on which the main unit 1 has performed the printing.

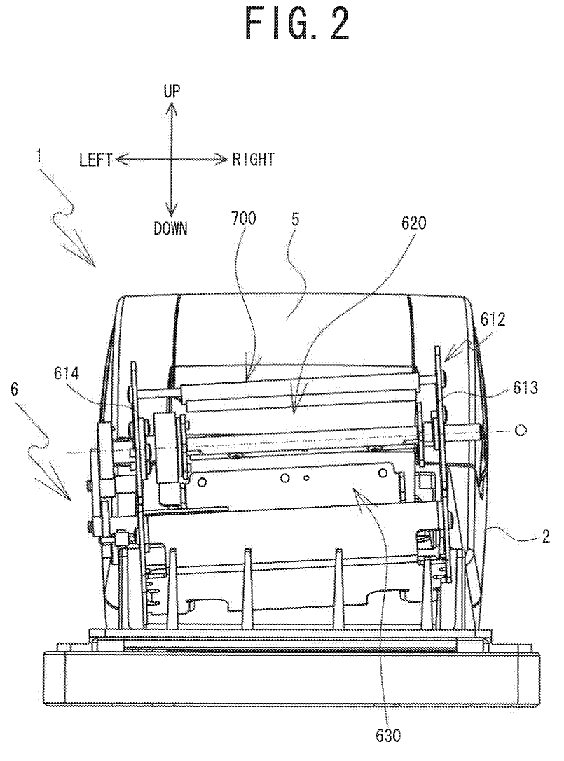

The configuration of the main unit 1 will be explained with reference to FIGS. 1 to 3. As shown in FIGS. 1 and 2, the main unit 1 has a rectangular parallelepiped shape that is long in the front-rear direction, with its upper surface rounded into an arc shape. The main unit 1 is provided with a housing 2 that covers the bottom portion of the main unit 1 and with a cover 5 that covers the top of the housing 2. A power switch 7 and various types of input keys (not shown in the drawings) are provided on the upper surface of the front end portion of the housing 2. The cover 5 opens and closes freely, supported by the rear edge of the main unit 1, which extends in the left-right direction. An outlet slot 21 that is long in the left-right direction is provided between the power switch 7 and the cover 5. After the printing, the tape 3A (refer to FIG. 3) is discharged from the outlet slot 21.

As shown in FIG. 3, a holder containing portion 4 that is configured to contain a tape holder 3 is provided in a space inside the housing 2. In a side view, the holder containing portion 4 is recessed downward in a circular arc shape. In the tape holder 3, the tape 3A is wound into a roll shape around a core 3B that has a substantially cylindrical shape. A holder shaft member 40 that has a substantially cylindrical shape is provided on the inner circumference side of the core 3B. The holder shaft member 40 supports the core 3B, around which the tape 3A is wound, such that the core 3B rotates around a central axis that is parallel to the left-right direction.

In the present embodiment, the tape 3A is a tape for making labels and has a three-layer structure (refer to the enlarged portion in FIG. 3). More specifically, the layers of the tape 3A are a release paper 301, an adhesive layer 302, and a heat-sensitive paper 303, in that order. To put another way, the release paper 301 is affixed to the back side of the heat-sensitive paper 303 through the adhesive layer 302. In the end, peeling off the release paper 301 makes it possible for the finished label (not shown in the drawings) to be affixed to an object or the like by the adhesive layer 302.

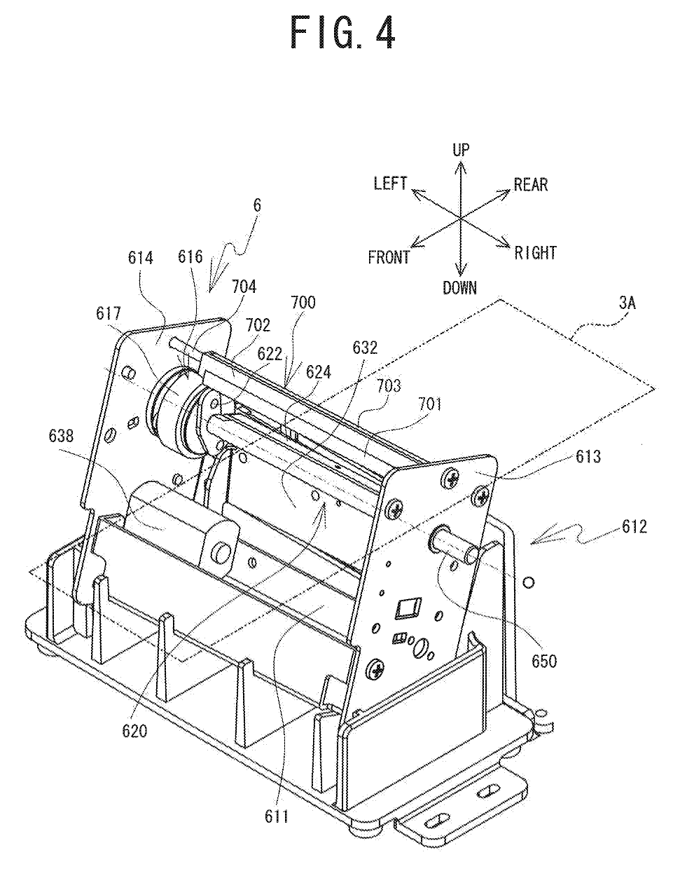

A thermal head 31 that is configured to perform the printing on the tape 3A is provided in a fixed position in front of the holder containing portion 4 (that is, on the downstream side of the holder containing portion 4 in the direction in which the tape 3A that is wound around the core 3B is fed). A platen roller 26 that is configured to be rotatable by a stepping motor that is not shown in the drawings is provided above the thermal head 31. The platen roller 26 is configured to pull out the tape 3A that is wound around the core 3B and is configured to feed the tape 3A along a feed path that extends forward toward the outlet slot 21. The thermal head 31 and the platen roller 26 are disposed opposite one another, with the feed path for the tape 3A passing between them. Note that the broken line in FIG. 1 (and in FIG. 4) indicates the feed path for the fed tape 3A.

A lever (not shown in the drawings) for moving the platen roller 26 up and down is provided to the left and in front of the holder containing portion 4. When the cover 5 is opened, the lever is rotated upward by the energizing force of a coil spring (not shown in the drawings), causing the platen roller 26 to move upward. This separates the platen roller 26 from the thermal head 31 and the tape 3A, so the main unit 1 is put into a state in which printing is disabled. When the cover 5 is open, the tape holder 3 can be removed from and put back into the holder containing portion 4. In contrast, when the cover 5 is closed, the lever is pressed downward by the cover 5, and the platen roller 26 moves downward. The platen roller 26 thus presses the tape 3A against the thermal head 31, so the main unit 1 is put into a state in which printing is enabled (refer to FIG. 3).

A control board 22 is configured to operate and control the main unit 1 is provided in the space inside the housing 2. The control board 22 is provided with a CPU, a ROM, a RAM, and the like that are not shown in the drawings. The CPU is configured to execute programs that are stored in advance in the ROM, while utilizing a temporarily storage function of the RAM. When the main unit 1 is in a state in which printing is enabled and a command is issued to start printing, the control board 22 feeds the tape 3A by rotationally driving the platen roller 26. In synchronization with the feeding of the tape 3A, the control board 22, by controlling the operation of the thermal head 31, causes the printing to be performed on the tape 3A that is being fed. After the printing is completed, the tape 3A is discharged from the outlet slot 21 and is then cut by the rotary cutter device 6, which will be described later, thus creating a label that is not shown in the drawings. The rotary cutter device 6 is also operated and controlled by the control board 22.

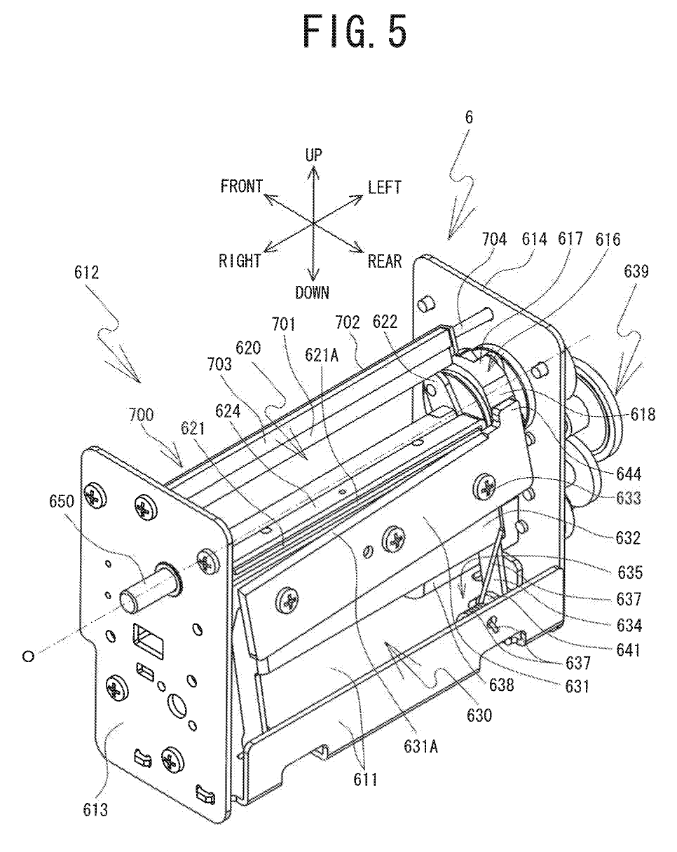

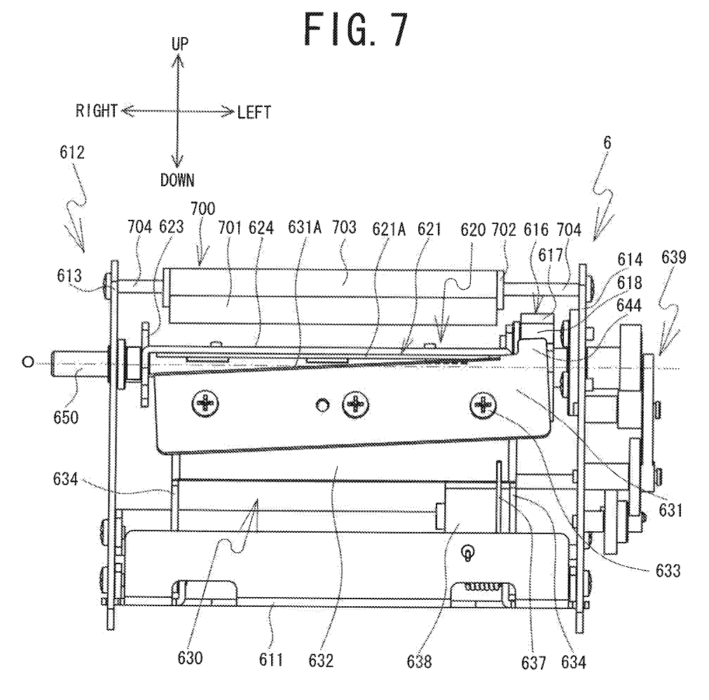

The configuration and operation of the rotary cutter device 6 will be explained with reference to FIGS. 4 to 7. The rotary cutter device 6 is provided with a housing 612, the rotating body 620, a holding body 630, and a blade member 700. The rotary cutter device 6 is configured to cut the tape 3A, which is printed by the thermal head 31, in a straight line by the coordinated operating of a rotary blade 621 and a fixed blade 631, which will be described later.

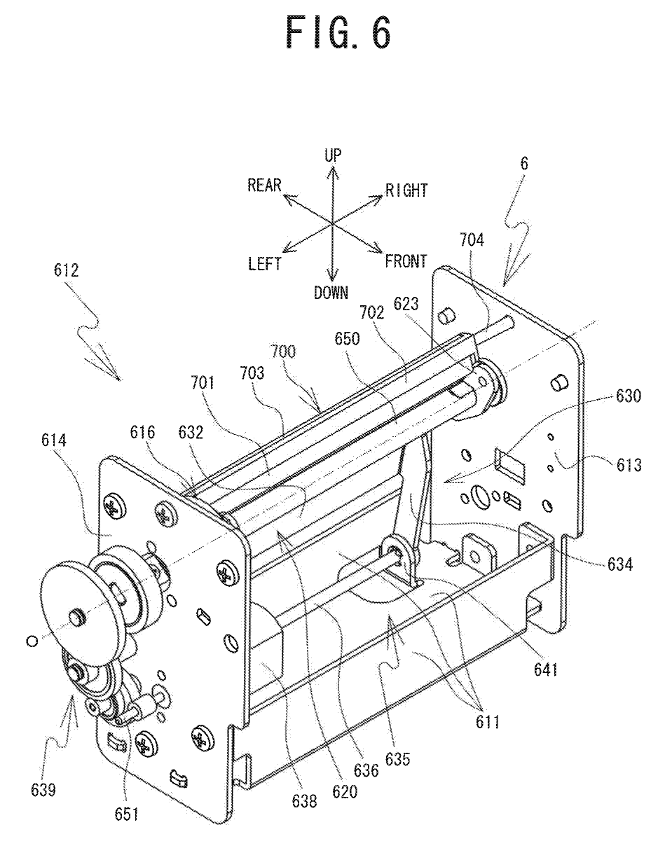

The housing 612 is provided with a first wall portion 613, a second wall portion 614, and a connecting portion 611. The first wall portion 613 is a wall portion that is provided at the right end of the housing 612, and extends obliquely upward toward the rear in the right side portion of the rotary cutter device 6. The second wall portion 614 is a wall portion that is provided at the left end of the housing 612, and extends obliquely upward toward the rear in the left side portion of the rotary cutter device 6. The connecting portion 611 connects the lower portion of the first wall portion 613 and the lower portion of the second wall portion 614. The connecting portion 611 is a wall portion that is provided in the lower portion of the housing 612, and front and rear edges of the connecting portion 611 are bent upward and extend upward to a certain degree (refer to FIG. 6).

Note that the housing 612 is disposed in the rotary cutter device 6 in an orientation in which the first wall portion 613 and the second wall portion 614 are tilted somewhat to the left from the vertical (refer to FIG. 2). In the rotary cutter device 6 that is shown in FIGS. 4 to 7, the housing 612 is disposed such that the orientations of the first wall portion 613 and the second wall portion 614 are aligned to the vertical to facilitate the explanation and make the drawings easier to understand.

The rotating body 620 is disposed between the first wall portion 613 and the second wall portion 614. The rotating body 620 is provided with a cam 616, a first bracket 622, a second bracket 623, a rotating shaft 650, and a rotary blade attachment portion 624. The cam 616 is provided on the right side of the second wall portion 614. The cam 616 surrounds the rotating shaft 650, and rotates in conjunction with the rotation of the rotating shaft 650.

The cam 616 is a circular cylinder for which a central axis O is defined as the axis line. The central axis O extends toward upper left to a certain degree (refer to FIG. 2). A notched portion 618 is provided on a portion of the outer circumferential face of the cam 616. The notched portion 618 is an area that is notched such that the outline of the circular shape is recessed toward the inside in a side view. The area on the outer circumferential face of the cam 616 other than the notched portion 618 is a pressing face 617. The pressing face 617 is a face for pressing, in a rearward direction, a receiving portion 644, which will be described later. The first bracket 622 is provided on the right side of the second wall portion 614. The second bracket 623 is provided on the left side of the first wall portion 613. The rotating shaft 650 is provided in the housing 612, extending such that the rotating shaft 650 connects the first bracket 622 and the second bracket 623, and is able to rotate around the central axis O. The rotary blade attachment portion 624 is provided on the rotating shaft 650 and extends in the direction of the central axis O. The rotary blade attachment portion 624 supports the rotary blade 621. The rotary blade 621 is configured to rotate around the central axis O in conjunction with the rotation of the rotating shaft 650.

The rotary blade 621 has a plate shape that is long in the direction of the central axis O. The rotary blade 621 extends in a first direction, which is the direction away from the central axis O (the direction that is radially toward the outside). A first cutting edge 621A is provided on the outer edge of the rotary blade 621 in the first direction that is farthest from the central axis O (that is, on the edge on the outer circumferential side of the rotating rotary blade 621). The first cutting edge 621A has a width that extends parallel to the central axis O.

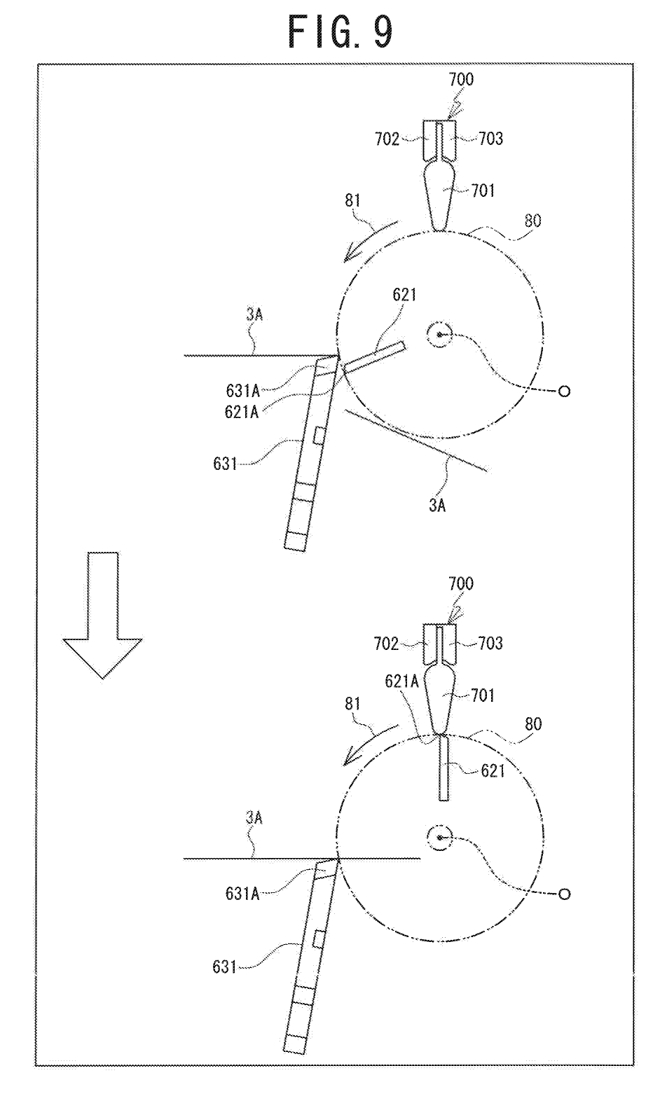

When the rotating body 620 rotates, the first cutting edge 621A describes a rotational trajectory 80 that is centered on the central axis O (refer to FIG. 9). When the rotary blade 621 cuts the tape 3A, the first cutting edge 621A rotates in a counterclockwise direction (a forward direction 81 that is shown in FIG. 9) in a left side view. The rotary blade 621 cuts the tape 3A against the fixed blade 631 as the first cutting edge 621A moves from above to below in relation to a second cutting edge 631A. It is preferable for a surface treatment (for example, fluorine coating, Tosico processing, or the like) to be carried out on at least the first cutting edge 621A of the rotary blade 621 that increases resistance of the first cutting edge 621A to the adhering of an adhesive 35. In the present embodiment, the entire rotary blade 621, including the first cutting edge 621A, is subjected to fluorine coating.

The holding body 630 has a plate-shaped holding portion 632 on which the fixed blade 631 is provided. The holding portion 632 has a pair of extending portions 634 that extend downward from the left and right ends of the holding portion 632. The holding body 630 is rotatably supported by a rocking support mechanism 635 such that the holding body 630 can rock in relation to the housing 612.

The rocking support mechanism 635 is provided with a left-right pair of hinge arms 641, a support shaft 636, and a coil spring 637. The left-right pair of the hinge arms 641 rise upward from the connecting portion 611 and have holes that pass through the hinge arms 641 in the left-right direction. The support shaft 636 is inserted into the holes in the pair of the hinge arms 641 such that the support shaft 636 rotates freely. The lower ends of the pair of the extending portions 634 are affixed to opposite ends of the support shaft 636. That is, the holding portion 632 is rotatably supported by the pair of the extending portions 634 such that the holding portion 632 can rock in relation to the housing 612.

The coil spring 637 is wound around the left end of the support shaft 636. One end (the rear end) of the coil spring 637 is affixed to a wall portion of the rear edge of the connecting portion 611. The other end (the upper end) of the coil spring 637 is in contact with the rear portion of the holding portion 632. The coil spring 637 energizes the holding portion 632 toward the front (in other words, in the direction toward the rotating body 620).

When the rotating body 620 rotates, before the first cutting edge 621A reaches the position where the first cutting edge 621A is opposite the second cutting edge 631A, the pressing face 617 of the cam 616 comes into contact with the receiving portion 644 of the fixed blade 631 and presses the receiving portion 644 in the direction that separates the receiving portion 644 from the rotational trajectory 80. The second cutting edge 631A moves away from the rotational trajectory 80 to a certain degree. When the rotating body 620 rotates farther, the notched portion 618 of the cam 616 reaches the position where the notched portion 618 is opposite the receiving portion 644, and the second cutting edge 631A is moved toward the rotational trajectory 80 by the energizing force of the coil spring 637. As the second cutting edge 631A is energized toward the rotational trajectory 80, the tape 3A is cut by the first cutting edge 621A and the second cutting edge 631A.

The fixed blade 631 is affixed by screws 633 to the rear face of the holding portion 632. The fixed blade 631 projects upward higher than the upper edge of the holding portion 632. The fixed blade 631 is provided on an outer side of the rotational trajectory 80 that is described by the first cutting edge 621A of the rotary blade 621 (refer to FIG. 9). The upwardly extending receiving portion 644 is provided on the upper left edge of the fixed blade 631. The receiving portion 644 is a component that is pressed toward the rear by the pressing face 617 of the cam 616. The second cutting edge 631A is provided on the upper edge of the fixed blade 631 to the right of the receiving portion 644. The second cutting edge 631A has a width that extends in the left-right direction and is positioned facing the rotational trajectory 80. The second cutting edge 631A cuts the tape 3A against the first cutting edge 621A of the rotary blade 621. The line along which the first cutting edge 621A extends (the direction of the central axis O) is inclined in relation to the line along which the second cutting edge 631A extends.

Therefore, when the rotating body 620 rotates and the tape 3A is cut, the rotary blade 621 and the fixed blade 631 cut the tape 3A with a scissoring action, such that the first cutting edge 621A and the second cutting edge 631A slide along one another in a straight line from the left edge to the right edge of the tape 3A. As stated above, the direction in which the first cutting edge 621A extends is inclined in relation to the direction in which the second cutting edge 631A extends. A shear angle is formed by the first cutting edge 621A and the second cutting edge 631A, so the tape 3A can be cut with a comparatively low shear force.

The blade member 700 is provided in a position that is opposite the rotational trajectory 80 and is different from the position of the fixed blade 631. In the present embodiment, the blade member 700 is disposed above the rotating body 620. The blade member 700 is provided with a cleaning body 701, a front-side holding body 702, a rear-side holding body 703, and a pair of support shafts 704.

The cleaning body 701 is an elastic member with a laterally long plate shape, having a width that extends parallel to the central axis O and being disposed approximately vertically in a side view. The thickness of the cleaning body 701 (that is, its width in the front-rear direction) decreases gradually from top to bottom, such that the thickness is the smallest at the lower edge. In a side view, the lower edge of the cleaning body 701 is positioned slightly below the contour line of the upper edge of the rotational trajectory 80, the contour line extending in the direction of the central axis O. The length of the front-side holding body 702 in the direction of the central axis O is almost the same as the width of the first cutting edge 621A.

It is good for the edge of the cleaning body 701 that slides along the first cutting edge 621A to be an elastic body. Examples of the material for the cleaning body 701 include nitrile butadiene rubber (NBR), silicone rubber, and the like. In the present embodiment, the entire cleaning body 701 is formed from NBR. Among the surfaces of the cleaning body 701, the surfaces that are close to the lower edge that is opposite the rotational trajectory 80 would preferably be subjected to a surface treatment (for example, halogen processing or the like) that improves their surface activity. In the present embodiment, halogen processing is carried out on the entire surface of the cleaning body 701.

The cleaning body 701 is fixed in place by being clamped between the front-side holding body 702 and the rear-side holding body 703. The front-side holding body 702 and the rear-side holding body 703 are plate-shaped bodies that extend in the direction of the central axis O and are positioned opposite one another in the front-rear direction. When the front-side holding body 702 and the rear-side holding body 703 are assembled together, they form a case body that holds the cleaning body 701. The lower portion of the cleaning body 701 extends downward from the case body that is formed by the front-side holding body 702 and the rear-side holding body 703. The pair of the support shafts 704, which respectively extend to the left and to the right, are provided on opposite ends of the front-side holding body 702. The support shafts 704 are fixed in place by being joined to the first wall portion 613 and the second wall portion 614, respectively.

A transmission mechanism for the driving force that rotates the rotary blade 621 will be explained. A motor 638 that is configured to drive the rotating body 620 is provided in the lower portion of the housing 612 on the second wall portion 614 side. A drive shaft 651 of the motor 638 passes through the second wall portion 614 and protrudes toward the left. The rotating shaft 650 of the rotating body 620 also passes through the second wall portion 614 and protrudes toward the left. A drive transmission mechanism 639 is provided on the left face of the second wall portion 614 (refer to FIG. 6). The drive transmission mechanism 639 is a gear train that is capable of operationally linking the drive shaft 651 and the rotating shaft 650. When the tape 3A is cut, the motor 638 rotates the rotating body 620 in the forward direction 81 (refer to FIG. 9) through the drive transmission mechanism 639. The tape 3A that has been inserted between the rotating body 620 and the holding body 630 is thus cut in a moving state.

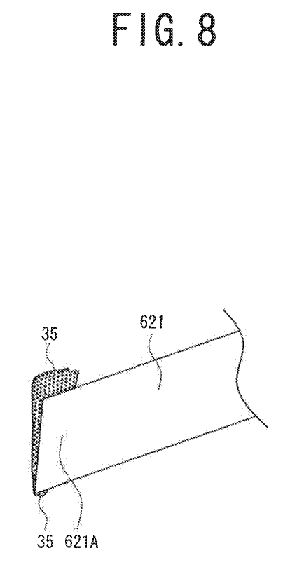

In the rotary cutter device 6, when the cutting of the tape 3A is performed, the adhesive 35 in the adhesive layer 302 of the tape 3A adheres to the first cutting edge 621A. The face of the first cutting edge 621A that is on the upstream side in relation to the forward direction 81 (refer to FIG. 9) is inclined such that the rotary blade 621 becomes narrower toward the first cutting edge 621A. The adhesive 35 particularly tends to adhere to the upstream face of the first cutting edge 621A. When the cutting of the tape 3A is continued, the adhesive 35 accumulates on the upstream face of the first cutting edge 621A, as shown in FIG. 8. This creates the possibility that the tape 3A that has been cut will stick to the adhesive 35 that has accumulated on the first cutting edge 621A. In the present embodiment, the blade member 700 is provided such that the adhesive 35 does not accumulate on the first cutting edge 621A.

The operation of cutting the tape 3A in the first embodiment will be explained with reference to FIG. 9. As explained previously, when the tape 3A is cut, the rotary blade 621 rotates in the forward direction 81. As shown in FIG. 9, when the rotary blade 621 rotates to the cutting position where the rotary blade 621 is opposite the fixed blade 631, the tape 3A is pinched between the first cutting edge 621A and the second cutting edge 631A and is cut. At this time, the adhesive 35 sometimes adheres to the upstream face of the first cutting edge 621A.

When the rotary blade 621 rotates beyond the cutting position, the rotary blade 621 arrives at a cleaning position, where the rotary blade 621 is opposite the blade member 700. The first cutting edge 621A touches the cleaning body 701, and as the cleaning body 701 elastically deforms, the cleaning body 701 slides along the upstream face of the first cutting edge 621A, which is moving along the rotational trajectory 80. At this time, when the adhesive 35 has adhered to the first cutting edge 621A, the adhesive 35 is removed by the cleaning body 701.

As explained above, in the rotary cutter device 6 according to the first embodiment, the rotary blade 621 is configured to rotate around the central axis O, and the fixed blade 631 is configured to be opposite the rotational trajectory 80. The tape 3A, which is a sheet-shaped object, is cut between the first cutting edge 621A and the second cutting edge 631A by the rotating of the rotary blade 621 around the central axis O. The blade member 700, which is configured to slide along the first cutting edge 621A, is provided in a position that is opposite the rotational trajectory 80 and is different from the position of the fixed blade 631.

Thus, in conjunction with the rotation of the rotary blade 621, the adhesive 35 that has adhered to the first cutting edge 621A can be removed by the blade member 700 that slides along the first cutting edge 621A. The adhesive 35 that has accumulated on the first cutting edge 621A of the rotary blade 621 can be removed safely and precisely without interrupting the work of cutting the tape 3A.

A second embodiment of the present disclosure will be explained. Hereinafter, the same reference numerals will be assigned to and explanations will be omitted for structures that are the same as those in the first embodiment, and only those points that are different from the first embodiment will be explained.

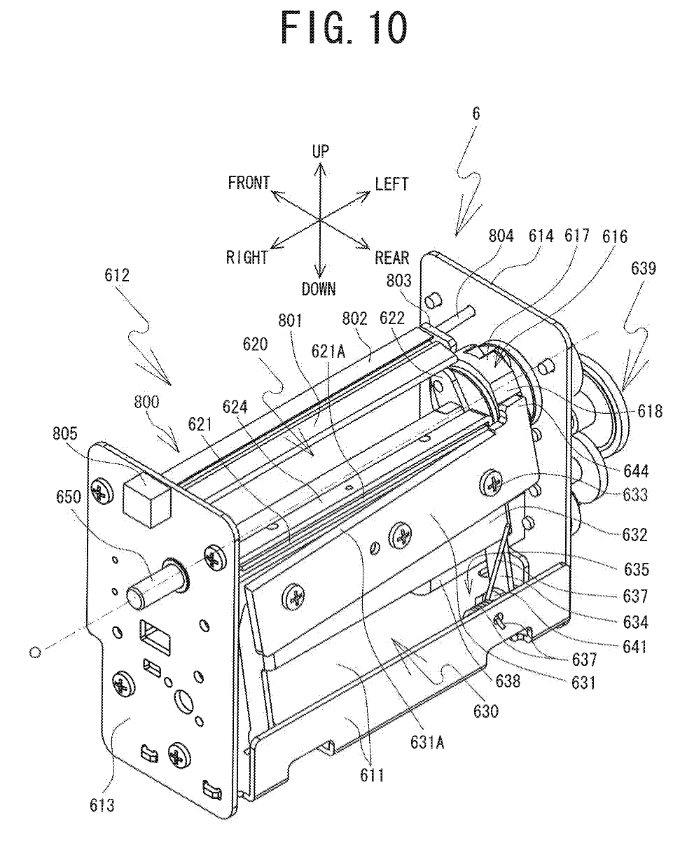

The rotary cutter device 6 according to the second embodiment will be explained with reference to FIG. 10. In the rotary cutter device 6 of the second embodiment, a blade member 800 is provided in a position that is opposite the rotational trajectory 80 and is different from the position of the fixed blade 631, in the same manner as the blade member 700 of the first embodiment. In the present embodiment, the blade member 800 is disposed above the rotating body 620. The blade member 800 is provided with a cleaning body 801, an upper-side holding body 802, a lower-side holding body 803, a pair of support shafts 804, and a plate drive mechanism 805.

In the same manner as the cleaning body 701, the cleaning body 801 is an elastic member with a laterally long plate shape, having a width that extends parallel to the central axis O. The length of the cleaning body 801 in the direction of the central axis O is almost the same as the width of the first cutting edge 621A. Unlike the cleaning body 701, the cleaning body 801 is disposed approximately horizontally in a side view. The thickness of the cleaning body 801 (that is, its width in the up-down direction) decreases gradually from the front toward the rear, such that the thickness is the smallest at the rear edge. The rear edge of the cleaning body 801 extends such that the rear edge of the cleaning body 801 is approximately congruent with the central axis O in a plan view. The same sort of material is used for the cleaning body 801 as for the cleaning body 701 of the first embodiment, and the same sort of surface treatment is applied.

The cleaning body 801 is fixed in place by being clamped between the upper-side holding body 802 and the lower-side holding body 803. The upper-side holding body 802 and the lower-side holding body 803 are plate-shaped bodies that extend in the direction of the central axis O and are positioned opposite one another in the up-down direction. When the upper-side holding body 802 and the lower-side holding body 803 are assembled together, they form a case body that holds the cleaning body 801. The rear portion of the cleaning body 801 extends rearward from the case body that is formed by the upper-side holding body 802 and the lower-side holding body 803. The pair of the support shafts 804, which respectively extend to the left and to the right, are provided on opposite ends of the upper-side holding body 802. The support shafts 804 are supported by the first wall portion 613 and the second wall portion 614, respectively, such that the support shafts 804 rotate freely. Therefore, the blade member 800 is configured to swing with the pair of the support shafts 804 serving as a pivot points.

The support shaft 804 that is supported by the first wall portion 613 is connected to the plate drive mechanism 805. A projecting piece (not shown in the drawings) that extends toward the front from the left end of the support shaft 804 is disposed in the interior of the plate drive mechanism 805. The plate drive mechanism 805 is provided with a support plate (not shown in the drawings) and a solenoid (not shown in the drawings). The support plate is configured to hold the cleaning body 801 in a horizontal state by supporting the projecting piece of the support shaft 804 from below. The solenoid is configured to press on the projecting piece of the support shaft 804 from below.

When the solenoid (not shown in the drawings) is on, the blade member 800 rotates of its own weight in a counterclockwise direction in a left side view. The cleaning body 801 is held in a horizontal state in a proximate position by the support plate (not shown in the drawings) that supports the projecting piece of the support shaft 804 from below. In a side view, the bottom face of the rear portion of the cleaning body 801 that is in the proximate position touches the contour line of the upper edge of the rotational trajectory 80, the contour line extending in the direction of the central axis O.

When the solenoid (not shown in the drawings) is off, the projecting piece of the support shaft 804 is pressed from below, and the blade member 800 rotates clockwise in a left side view. The cleaning body 801 is held in a distant position by the solenoid (not shown in the drawings) that presses on the projecting piece of the support shaft 804 from below, the cleaning body 801 being held in a state in which the cleaning body 801 is inclined at a specified angle (30 degrees, for example) from the horizontal state. In a side view, the bottom face of the rear portion of the cleaning body 801 that is in the distant position is positioned slightly above the contour line of the upper edge of the rotational trajectory 80. That is, the cleaning body 801 of the blade member 800 is configured to swing between the proximate position and the distant position.

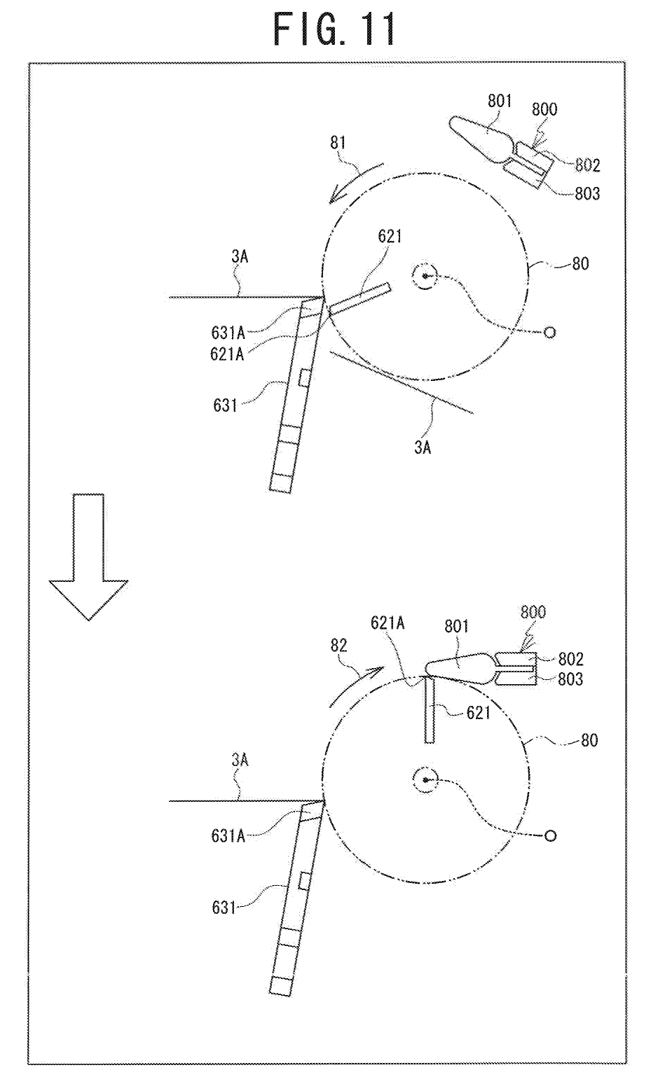

The operation of cutting the tape 3A in the second embodiment will be explained with reference to FIG. 11. As shown in FIG. 11, when the tape 3A is cut, the rotary blade 621 rotates in the forward direction 81. When the rotary blade 621 rotates in the forward direction 81, the solenoid (not shown in the drawings) is set to off, and the cleaning body 801 is held in the distant position. When the rotary blade 621 rotates to the cutting position where the rotary blade 621 is opposite the fixed blade 631, the tape 3A is pinched between the first cutting edge 621A and the second cutting edge 631A and is cut. When the rotary blade 621 rotates to the cleaning position where the rotary blade 621 is opposite the blade member 800, the first cutting edge 621A passes directly below the cleaning body 801 without touching the cleaning body 801.

[0063]When the operation of cleaning the first cutting edge 621A is performed, the rotary blade 621 rotates in the clockwise direction (a reverse direction 82) in a left side view. When the rotary blade 621 rotates in the reverse direction 82, the solenoid (not shown in the drawings) is set to on, and the cleaning body 801 is held in the proximate position. In this case, when the rotary blade 621 rotates to the cleaning position where the rotary blade 621 is opposite the blade member 800, the first cutting edge 621A touches the cleaning body 801. As the cleaning body 801 elastically deforms, the cleaning body 801 slides along the upstream face of the first cutting edge 621A, which is moving along the rotational trajectory 80. At this time, when the adhesive 35 has adhered to the first cutting edge 621A, the adhesive 35 is removed by the cleaning body 801.

As described previously, the face of the first cutting edge 621A that is on the upstream side in relation to the forward direction 81 is inclined such that the rotary blade 621 becomes narrower toward the first cutting edge 621A. In contrast, when the cleaning body 801 is positioned in the proximate position, the bottom face of its rear portion is inclined downward from the rear toward the front. Therefore, the angle that is formed between the upstream face of the first cutting edge 621A and the bottom face of the rear portion of the cleaning body 801 is small, making it easier for the upstream face of the first cutting edge 621A to slide along the bottom face of the rear portion of the cleaning body 801. Accordingly, the adhesive 35 can be removed from the first cutting edge 621A as the rotary blade 621 is rotated smoothly.

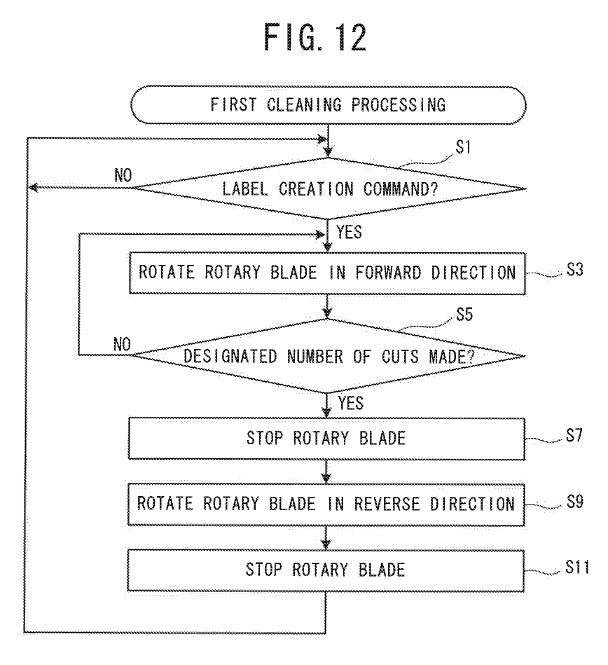

Various types of patterns can be used for the timing at which the cleaning operation that is described above is performed. Processing patterns for performing the cleaning operation that is described above at preferred times will be explained with reference to FIGS. 12 to 15 as examples of the processing that the control board 22 performs. Note that each of the cleaning processing routines that are hereinafter used as examples is performed by the CPU of the control board 22.

In first cleaning processing that is shown in FIG. 12, a determination is made as to whether or not a label creation command has been issued (Step S1). For example, if a user has issued a printing start command from an operation portion that is not shown in the drawings, a determination is made that the label creation command has been issued. In a case where the label creation command has not been issued (NO at Step S1), the processing returns to Step S1. In a case where the label creation command has been issued (YES at Step S1), the previously described label creation operation is performed. At this time, the operation of the rotary cutter device 6 is controlled as hereinafter described.

First, the rotary blade 621 is rotated in the forward direction 81 (Step S3). At this time, the solenoid (not shown in the drawings) is set to off, as described previously, and the cleaning body 801 is held in the distant position. Thus the cleaning body 801 does not interfere with the rotary blade 621, and the printed tape 3A is cut in synchronization with the printing operation of the main unit 1. Next, a determination is made as to whether or not a designated number of cuts have been made (Step S5). The CPU of the control board 22 counts, as the number of cuts of tape 3A, the number of times that the rotary blade 621 has made one full revolution (that is, the number of times that the rotary blade 621 has passed by the cutting position) since the start of the label creation operation. In a case where the counted number of cuts has reached a number of labels to be created that the user designated when the printing operation started, a determination is made that the designated number of cuts have been made. In a case where the designated number of cuts have not been made (NO at Step S5), the processing returns to Step S3.

In a case where the designated number of cuts have been made (YES at Step S5), the rotation of the rotary blade 621 is stopped (Step S7) so that the label creation operation will be terminated. Next, the rotary blade 621 is rotated in the reverse direction 82 (Step S9). At this time, the solenoid (not shown in the drawings) is set to on, as described previously, and the cleaning body 801 is held in the proximate position. The adhesive 35 that has adhered to the first cutting edge 621A is thus removed by the cleaning body 801. When the rotary blade 621 has passed by the cleaning position a specified number of times (for example, five times), the rotation of the rotary blade 621 is stopped (Step S11), and the processing returns to Step S1.

According to the first cleaning processing, the operation of cleaning the first cutting edge 621A is performed every time the label creation operation is terminated. Therefore, when the next label creation operation is performed, the label creation operation can be started in a state in which none of the adhesive 35 is adhering to the first cutting edge 621A.

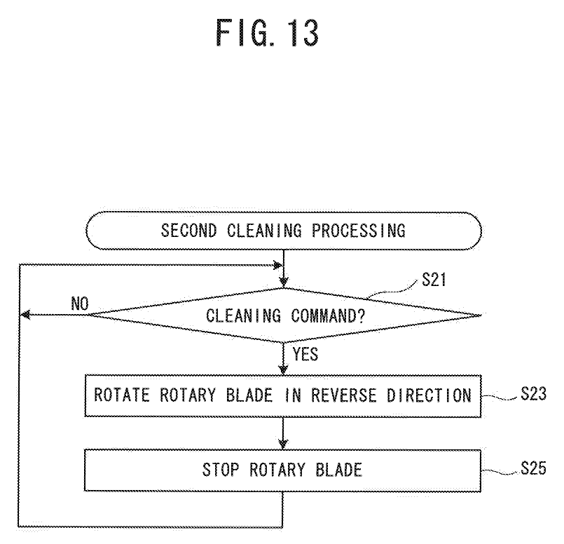

In second cleaning processing that is shown in FIG. 13, first, a determination is made as to whether or not a cleaning command has been issued (Step S21). For example, if the user has issued a cleaning start command from the operation portion that is not shown in the drawings, a determination is made that the cleaning command has been issued. In a case where the cleaning command has not been issued (NO at Step S21), the processing returns to Step S21. In a case where the cleaning command has been issued (YES at Step S21), the rotary blade 621 is rotated in the reverse direction 82 (Step S23), in the same manner as at Step S9. Thereafter, the rotation of the rotary blade 621 is stopped (Step S25), and the processing returns to Step S21.

According to the second cleaning processing, the operation of cleaning the first cutting edge 621A is performed every time the user issues the cleaning start command. Therefore, the adhesive 35 can be removed from the first cutting edge 621A at a time of the user's choosing.

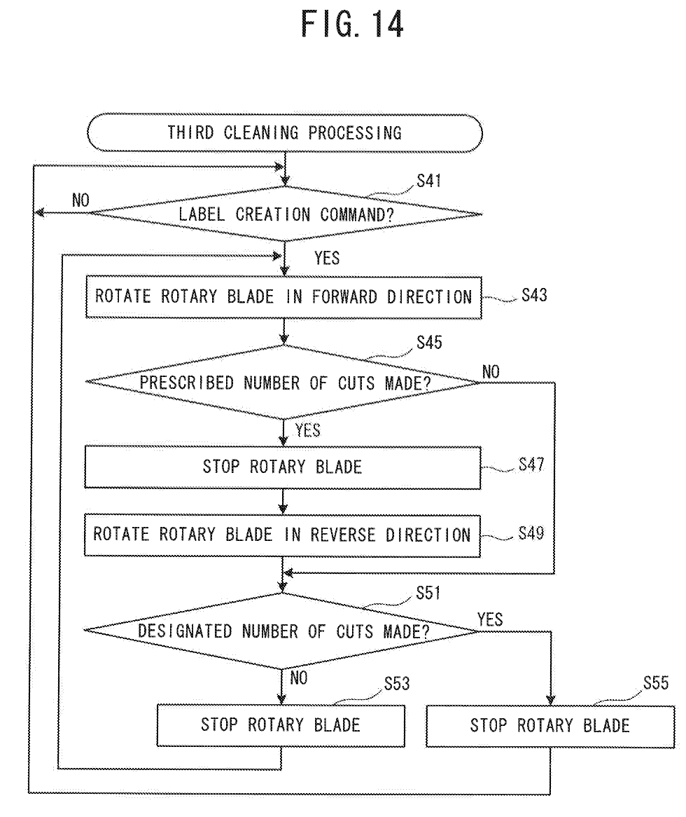

In third cleaning processing that is shown in FIG. 14, first, a determination is made as to whether or not the label creation command has been issued (Step S41), in the same manner as at Step S1. In a case where the label creation command has not been issued (NO at Step S41), the processing returns to Step S41. In a case where the label creation command has been issued (YES at Step S41), the rotary blade 621 is rotated in the forward direction 81 (Step S43) in the same manner as at Step S3, and the printed tape 3A is cut. Next, a determination is made as to whether or not a prescribed number of cuts have been made (Step S45). In a case where the counted number of cuts has reached a prescribed number (for example, 100) that has been set in advance, a determination is made that the prescribed number of cuts have been made.

In a case where the prescribed number of cuts have been made (YES at Step S45), the rotation of the rotary blade 621 is stopped (Step S47). Then the rotary blade 621 is rotated in the reverse direction 82 (Step S49), in the same manner as at Step S9. At this time, the CPU of the control board 22 interrupts the label creation operation. After Step S49 has been performed, as well as in a case where the prescribed number of cuts have not been made (NO at Step S45), a determination is made as to whether or not the designated number of cuts have been made (Step S51), in the same manner as at Step S5. In a case where the designated number of cuts have not been made (NO at Step S51), the rotation of the rotary blade 621 is stopped (Step S53), the processing returns to Step S43, and the label creation operation is restarted. In a case where the designated number of cuts have been made (YES at Step S51), the rotation of the rotary blade 621 is stopped (Step S55), and the processing returns to Step S41.

According to the third cleaning processing, the operation of cleaning the first cutting edge 621A is performed every time the tape 3A has been cut the prescribed number of times during the performing of the label creation operation. It is therefore possible to prevent the occurrence of an error that is caused by the adhesive 35 that has accumulated on the first cutting edge 621A during the performing of the label creation operation (for example, clinging of the tape 3A to the first cutting edge 621A after the tape 3A is cut).

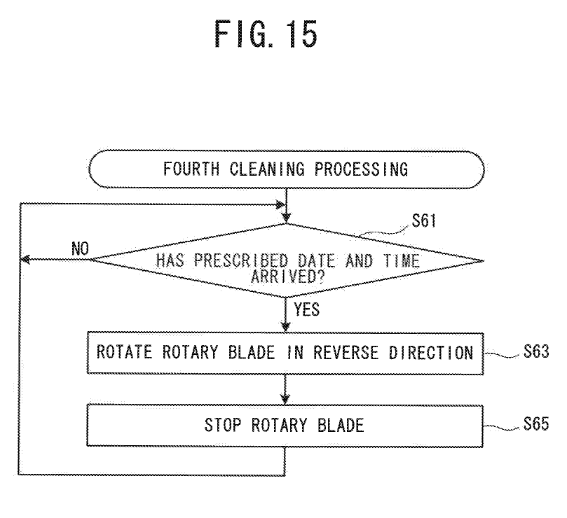

In fourth cleaning processing that is shown in FIG. 15, first, a determination is made as to whether or not a prescribed date and time has arrived (Step S61). The CPU of the control board 22 uses a built-in timer to track the current date and time. In a case where the current date and time has reached a predetermined date and time (for example, Jan. 10, 2013, 8:00 a.m.), a determination is made that the prescribed date and time has arrived. In a case where the prescribed date and time has not arrived (NO at Step S61), the processing returns to Step 61. In a case where the prescribed date and time has arrived (YES at Step S61), the rotary blade 621 is rotated in the reverse direction 82 (Step S63), in the same manner as at Step S9. Thereafter, the rotation of the rotary blade 621 is stopped (Step S65), and the processing returns to Step S61.

According to the fourth cleaning processing, the operation of cleaning the first cutting edge 621A is performed every time the current date and time reaches the prescribed date and time. The adhesive 35 can be removed from the first cutting edge 621A at a prescribed date and time that the user has freely chosen (for example, before work starts, after work is over, or the like). Note that at Step S61, a determination may instead be made as to whether or not the time that has elapsed since a specified time (for example, the time when the preceding round of the label creation operation was terminated) has reached a prescribed time.

As explained above, in the rotary cutter device 6 according to the second embodiment, the adhesive 35 that has accumulated on the first cutting edge 621A of the rotary blade 621 can be removed safely and precisely without interrupting the work of cutting the tape 3A, in the same manner as in the first embodiment. Furthermore the blade member 800 is configured to move between the proximate position, where it touches the first cutting edge 621A of the rotating rotary blade 621, and the distant position, where it is separated from the first cutting edge 621A of the rotating rotary blade 621. It is therefore possible to cause the blade member 800 to remove the adhesive 35 from the first cutting edge 621A and to retract the blade member 800 such that it does not interfere with the rotation of the rotary blade 621.

When the rotary blade 621 is rotated in the forward direction 81, the plate drive mechanism 805 moves the blade member 800 to the distant position. When the rotary blade 621 is rotated in the reverse direction 82, the plate drive mechanism 805 moves the blade member 800 to the proximate position. Therefore, at the time when the tape 3A is cut, the blade member 800 is retracted, and the rotary blade 621 is able to rotate smoothly. During the operation of cleaning the first cutting edge 621A, the blade member 800 can reliably be made to touch the first cutting edge 621A.

The present disclosure is not limited to the embodiments that have been described above, and various types of modifications can be made. For example, the rotary cutter device 6 is not limited to being provided outside the main unit 1. The rotary cutter device 6 may also be built into the main unit 1.

The position of the blade member 700 is not limited to being above the rotating body 620, and the blade member 700 may also be any position that is opposite the rotational trajectory 80 in a different position from the fixed blade 631. For example, the blade member 700 may also be provided below or to the side of the rotating body 620. The number, the size, the shape, and the like of the blade member 700 can be modified as desired, and a plurality of the blade members 700 may also be provided in a single one of the rotary cutter device 6. The same sorts of modifications may also be made for the blade member 800.

The plate drive mechanism 805 is not limited to being a mechanism that has the support plate and the solenoid that are not shown in the drawings, and the plate drive mechanism 805 needs only be able to control the movement of the blade member 800 between the proximate position and the distant position. For example, the plate drive mechanism 805 may also control the position of the blade member 800 by using a motor that rotates the support shafts 804.

The apparatus and methods described above with reference to the various embodiments are merely examples. It goes without saying that they are not confined to the depicted embodiments. While various features have been described in conjunction with the examples outlined above, various alternatives, modifications, variations, and/or improvements of those features and/or examples may be possible. Accordingly, the examples, as set forth above, are intended to be illustrative. Various changes may be made without departing from the broad spirit and scope of the underlying principles.

What is claimed is:

1. A rotary cutter device, comprising:
a rotary blade that is configured to be rotatable around a central axis, the rotary blade having a first cutting edge on an end of the rotary blade that is farthest from the central axis, the first cutting edge being a cutting edge that has a width that extends parallel to the central axis;
a fixed blade that is provided on an outer side of a trajectory that is described by the first cutting edge, the fixed blade having a second cutting edge that is a cutting edge that is opposite the trajectory;
a control portion that is configured to cause the rotary blade to rotate toward the fixed blade in a first direction around the central axis; and
a blade member that is provided opposite the trajectory in a different position from the fixed blade, the blade member being a plate-shaped member that has a width that extends parallel to the central axis and that has a slide portion that is configured to slide in relation to the first cutting edge of the rotating rotary blade.

2. The rotary cutter device according to claim 1, wherein
the slide portion is an elastic body.

3. The rotary cutter device according to claim 1, wherein
the slide portion has been subjected to a surface treatment that increases a surface activity.

4. The rotary cutter device according to claim 1, wherein
the first cutting edge has been subjected to a surface treatment that increases resistance of the first cutting edge to adhering of an adhesive.

5. The rotary cutter device according to claim 1, wherein
the blade member is configured to move between a first position where the slide portion is able to contact the trajectory and a second position where the slide portion is able to being separated from the trajectory.

6. The rotary cutter device according to claim 5, wherein
the control portion is further configured to cause the rotary blade to rotate around the central axis in a second direction at a first time, the second direction being the reverse of the first direction, and
the rotary cutter device further comprises:
a position control portion that is configured to move the blade member to the second position in a case where the rotary blade is rotated in the first direction, and that is configured to move the blade member to the first position in a case where the rotary blade is rotated in the second direction.

7. The rotary cutter device according to claim 6, wherein
the control portion is further configured to cause the rotary blade to rotate in the second direction in a case where an operation that cuts an object has been terminated.

8. The rotary cutter device according to claim 6, wherein
the control portion is further configured to cause the rotary blade to rotate in the second direction in a case where the number of times that an object has been cut by the rotary blade has reached a specified value.

9. The rotary cutter device according to claim 6, wherein
the control portion is further configured to cause the rotary blade to rotate in the second direction in a case where one of the current date and time and an elapsed time since a second time has reached a specified value.
